(19) United States
(12) Patent Application Publication
(10) Pub. No.: US 2006/0106771 A1
(43) Pub. Date: May 18, 2006

(54) Dynamic optimization of communication of data structures

(75) Inventors: Alan A. Donovan, New York, NY (US); Stephen J. Fink, Yorktown Heights, NY (US); Darrell Reimer, Tarrytown, NY (US)

Correspondence Address: MICHAEL J. BUCHENHORNER, ESQ;HOLLAND & KNIGHT, 701 BRICKELL AVENUE, MIAMI, FL, 33131, US

(73) Assignee: International Business Machines Corporation

(21) Appl. No.: 10/988,775

(22) Filed: Nov. 15, 2004

(51) Int. Cl. G06F 17/30

(52) U.S. Cl. 707/3

(57) ABSTRACT

A method for communicating information in a data structure between applications includes receiving a request from a first application for sending information in a data structure to a second application. The method further includes reading information from a run-time environment of the first application and identifying, based on the information, portions of the data structure to send. The method further includes marshalling the portions of the data structure that were identified and sending the portions of the data structure that were marshalled to the second application.

### CROSS-REFERENCE TO RELATED APPLICATIONS

Not Applicable.

### STATEMENT REGARDING FEDERALLY SPONSORED-RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of communications and more particularly relates to the field of communication of data structures between computer nodes.

### BACKGROUND OF THE INVENTION

Communicating processes in software systems require sharing of data and often communicate by exchanging messages containing the necessary data. Historically, message-passing processes spend a significant computational effort marshalling the data: gathering the relevant parts of the data from the memory of the sending program, and assembling them into a canonical serial format (or wire protocol). This serialized data is then transmitted to the receiver process—for example, by writing it to a file or by streaming it over a network—which then unmarshals the message into the desired format.

Some programming languages provide facilities to automate this process, which is often referred to as serialization. Typically, a serialization library uses class meta-data, which is provided by the programming language's runtime-system. This meta-data describes the structure of the types and data structures in the system, and enables the serialization support to automatically marshal and unmarshal program data structures. The whole process may be completely transparent to the user, encapsulated by a single procedure call—for example, send(x) in the sender, y:=recv( ) in the receiver. Although this automatic facility reduces programmer effort, it may introduce significant computational work if the serialized data structure is large.

As an optimization, some object-oriented programming languages allow the user to specify that object-graph edges originating at certain object fields are not to be traversed during marshalling. In object oriented programming languages, a data structure will often be represented as a graph of objects, wherein each object in the data structure contains fields that hold pointers or references to other objects in the data structure. For some data structures, this annotation can significantly reduce the size of the serialized format. Reachable fields so marked are not considered part of the persistent state of the object, but may be used to hold derived or cached values, for example.

For example, the Java standard library contains a serialization mechanism in the classes java.util.ObjectOutputStream and java.util.ObjectInputStream. The programmer may label fields of Java classes transient to prevent them from being serialized. One major limitation of this approach is that Java only allows a pointer to be declared transient or not depending on the declared field. The contents of a particular field will either always be transient and thus not communicated, or will always be considered persistent and communicated. However, there are situations where better performance could be obtained if one could defer the decision of what data to communicate until run-time, when more information is available.

Therefore, there is a need to overcome problems with the prior art as discussed above, and more particularly a need to make the process of communicating data structures more efficient.

### SUMMARY OF THE INVENTION

Briefly, according to an embodiment of the invention, a method for communicating information in a data structure between applications includes receiving a request from a first application for sending information in a data structure to a second application. The method further includes reading information from a run-time environment of the first application and identifying, based on the information, portions of the data structure to send. The method further includes marshalling the portions of the data structure that were identified and sending the portions of the data structure that were marshalled to the second application.

In another embodiment of the present invention, an information processing system for communicating information in a data structure between applications is disclosed. The information processing system includes a first application for sending information in a data structure to a second application. The information processing system further includes a processor configured for reading information from a run-time environment of the first application, identifying, based on the information, portions of the data structure to send and marshalling the portions of the data structure that were identified. The information processing system further includes a transmitter for sending the portions of the data structure that were marshalled to the second application.

In yet another embodiment of the present invention, a computer readable medium including computer instructions for communicating information in a data structure between applications is disclosed. The computer instructions includes instructions for receiving a request from a first application for sending information in a data structure to a second application. The computer instructions further include instructions for reading information from a run-time environment of the first application and identifying, based on the information, portions of the data structure to send. The computer instructions further include instructions for marshalling the portions of the data structure that were identified and sending the portions of the data structure that were marshalled to the second application.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is block diagram showing a high-level network architecture of one embodiment of the present invention.

FIG. 2 is a flow chart depicting the control flow of the marshalling process, in one embodiment of the present invention.

FIG. 3 is a flow chart depicting the control flow of the unmarshalling process, in one embodiment of the present invention.

FIG. 4 is a block diagram depicting the marshalling process, in one embodiment of the present invention.

FIG. 5 is a block diagram depicting the unmarshalling process, in one embodiment of the present invention

FIG. 6 is a high level block diagram showing an information processing system useful for implementing one embodiment of the present invention.

### DETAILED DESCRIPTION

The present invention provides a method, computer readable medium and information processing system for communicating information in a data structure, such as an object, between applications or among components of a computing system. A first application, or component of the computing system, can request to send information in an object to a second application, or component of the computing system. Current run-time environment values, such as time of day or type of recipient, of the first application or component are read. Based on the read run-time environment values, portions of the object are identified for sending. Subsequently, the portions of the object that were identified are marshalled and transmitted to the second application or component.

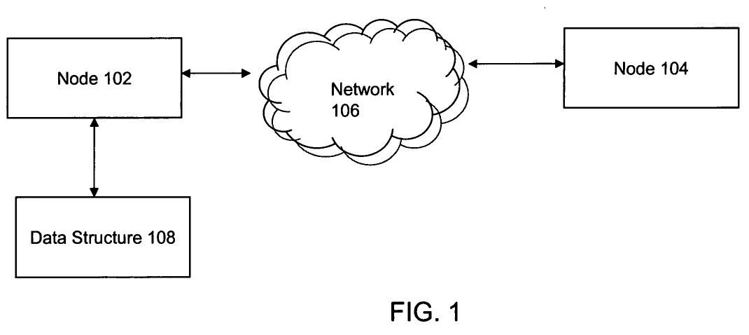

FIG. 1 is block diagram showing a high-level network architecture of one embodiment of the present invention. FIG. 1 shows a first node 102 and a second node 104 connected to a network 106. Nodes 102 and 104 can be applications, components of a larger application, computers running applications or any other information processing systems capable of executing applications. In an embodiment of the present invention, nodes 102 and 104 can comprise any commercially available computing system that can be programmed to offer the functions of the present invention. In another embodiment of the present invention, node 104 can comprise a client computer running a client application that interacts with a node 102 as a server computer in a client-server relationship.

In an embodiment where nodes 102 and 104 are applications or components of applications, the nodes can be implemented as hardware, software or any combination of the two. The applications or components of applications can be located in a distributed fashion in both nodes 102 and 104, as well as other nodes. In this embodiment, the applications or components of applications of nodes 102 and 104 operate in a distributed computing paradigm.

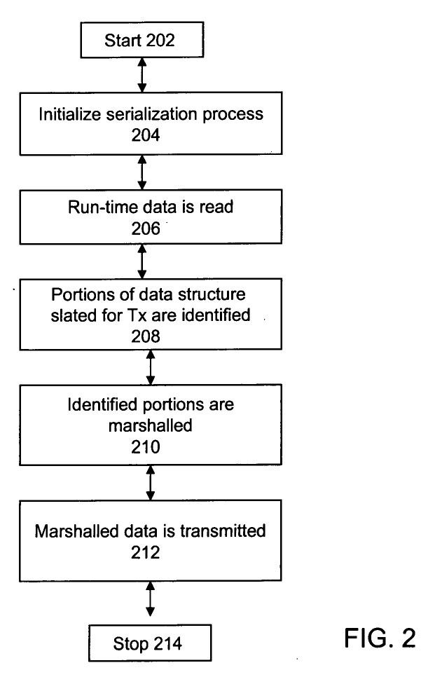

FIG. 1 further shows a data structure 108, such as an object, including information, such as variables, constants, fields, pointers, other objects and the like. In an embodiment of the present invention, the data structure 108 can be any data structure of an object-oriented programming language. The process of the present invention, allows for certain portions of the information in data structure 108 to be marshalled by node 102, transmitted through the network 106 and received by node 104, where the information is unmarshalled. This process is described in greater detail with reference to FIGS. 2-4 below.

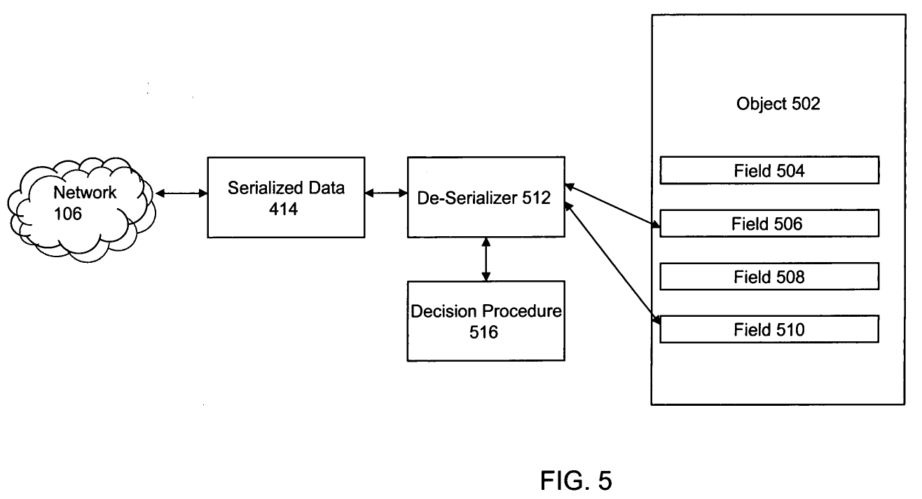

In an embodiment of the present invention, the computer systems of the nodes 102 and 104 are one or more Personal Computers (PCs) (e.g., IBM or compatible PC workstations running the Microsoft Windows operating system, Macintosh computers running the Mac OS operating system, or equivalent), Personal Digital Assistants (PDAs), hand held computers, palm top computers, smart phones, game consoles or any other information processing devices. In another embodiment, the computer systems of the nodes 102 and 104 are a server system (e.g., SUN Ultra workstations running the SunOS operating system or IBM RS/6000 workstations and servers running the AIX operating system). The computer systems of the nodes 102 and 104 are described in greater detail below with reference to FIG. 5.

In an embodiment of the present invention, the network 106 is a circuit switched network, such as the Public Service Telephone Network (PSTN). In another embodiment, the network 106 is a packet switched network. The packet switched network is a wide area network (WAN), such as the global Internet, a private WAN, a local area network (LAN), a telecommunications network or any combination of the above-mentioned networks. In yet another embodiment, the network 106 is a wired network, a wireless network, a broadcast network or a point-to-point network.

It should be noted that although nodes 102 and 104 are shown as separate entities in FIG. 1, the functions of both entities may be integrated into one entity. It should also be noted that although FIG. 1 shows only two nodes, the present invention supports any number of nodes.

FIG. 2 is a flow chart depicting the control flow of the marshalling process, in one embodiment of the present invention. FIG. 2 shows the sequence of events that occur when an application or component of an application, such as node 102, marshals data for transmission to a second node 104. The control flow of FIG. 2 beings with step 202 and flows directly to step 204. In step 204, the serialization process at node 102 is initiated, for example, by node 102 in an attempt to send required data, from a data structure 108, to node 104. This action spawns the initiation of the decision procedure of the present invention.

In step 206, the decision procedure begins by reading run-time data of the node 102. Examples of run-time data that can be read include time of day, existence of a previous occurrence, a type of the second application, a value associated with the second application and a bandwidth value. In step 208, based on the run-time data of the node 102 that was read in step 206 above, portions of the data structure 108 are identified.

In step 210′, based on the portions of the data structure 108 that were identified in step 208 above, the serialization process marshals the portions of the data structure 108 that were identified. In step 212, the marshaled data is transmitted to the second node 104. In step 214, the control flow of FIG. 2 ceases.

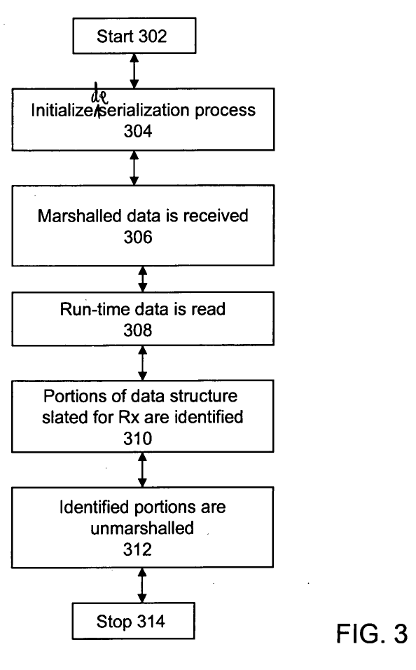

FIG. 3 is a flow chart depicting the control flow of the unmarshalling process, in one embodiment of the present invention. FIG. 3 shows the sequence of events that occur when an application or component of an application, such as node 104, unmarshals data received from node 102. The control flow of FIG. 3 beings with step 302 and flows directly to step 304. In step 304, the de-serialization process at node 104 is initiated, for example, by node 104 in an attempt to receive and unmarshal required data, from a data structure 108, sent by node 102. This action spawns the initiation of the decision procedure of the present invention.

In step 306, the marshaled data is received by the second node 104. In step 308, the decision procedure begins by reading meta-data embedded in the serialized message that describes the contents of the serialized data structure. In step 310, based on the data that was read in step 308 above, portions of the data structure 108 are identified for unmarshalling.

In step 312, based on the portions of the data structure 108 that were identified in step 310 above, the de-serialization process unmarshals the portions of the data structure 108 that were identified. In step 314, the control flow of FIG. 3 ceases.

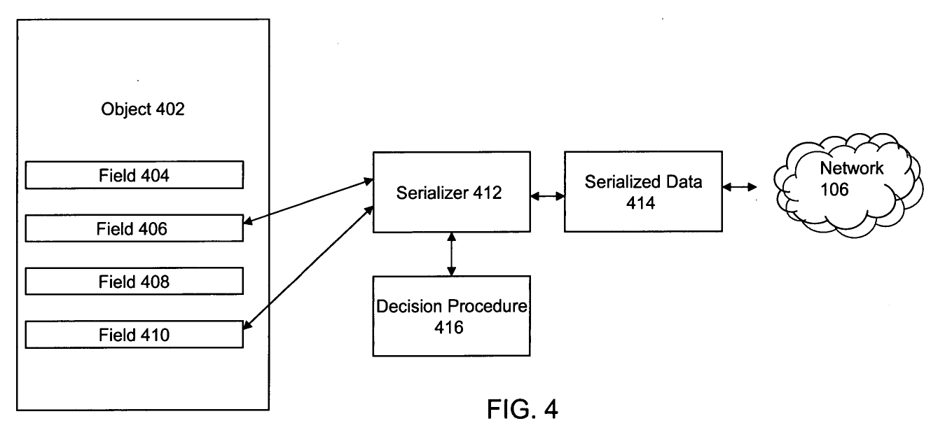

FIG. 4 is a block diagram depicting the marshalling process, in one embodiment of the present invention. FIG. 4 shows a data structure, such as object 402, including information such as variables, constants, fields, pointers, other objects and the like. Object 402 includes four data fields, filed 404, field 406, field 408 and field 410. The node 102 receives a request to transmit data from the object 402 to the node 104. The serializer 412, representing the serialization process of the node 102, consults the decision procedure 416 of the present invention, wherein certain portions of the object 402 are identified for marshalling and transmission. The decision procedure decides that fields 406 and 410 shall be marshalled for transmission to node 104. Fields 404 and 408 shall not be marshalled for transmission to node 104.

Subsequently, the serializer 412 marshals the fields 406 and 410 and produces the serialized data 414, which is then transmitted to the node 104 via the network 106.

FIG. 5 is a block diagram depicting the unmarshalling process, in one embodiment of the present invention. FIG. 5 shows that the serialized data 414 is received by the node 104 from node 102 via the network 106.

FIG. 5 shows a data structure, such as object 502, including information such as that described for object 402 in FIG. 4 above. Object 502 includes four data fields, filed 504, field 506, field 508 and field 510. The node 104 receives a request to receive data for the object 502. The de-serializer 512, representing the de-serialization process of the node 104, consults the decision procedure 516 of the present invention, wherein certain portions of the serialized data 414 are identified for unmarshalling into object 502. The decision procedure 516 reads meta-data embedded in the serialized message that describes the contents of the serialized data structure. The decision procedure decides that fields 506 and 510 shall be unmarshalled from the serialized data 414. Information for fields 504 and 508 shall not be unmarshalled from the serialized data 414. Subsequently, the de-serializer 512 unmarshals data from the serialized data 414 into fields 506 and 510.

Illustrated below are three examples of decision procedures (such as 416). For these examples, consider a stock-trading application, with a client application 104 that communicates with a server application 102 considering individual equities. We suppose that the server 102 sends to the client 104 a data structure 108 representing an individual stock with the following components: a) the name of the stock, b) the current price of the stock, c) a history of prices for the stock, d) a document which provides terms and conditions under which the client may initiate a trade of this stock. Below is an example class definition of such a data structure:

class Stock {
String name;
Double currentPrice;
Document priceHistory;
Document termsAndConditions;}

Shown are three examples under which the server application 102 utilizes one embodiment of the present invention to optimize the communication of a Stock data structure to a requesting client 104, depending on runtime data governing the current transaction. In each case, the programmer or the server application 102 will have encoded a decision procedure 416 in a function getRequiredFields( ). This function returns a four-bit quantity, where each bit corresponds to a field of the Stock data structure. The bits are encoded, from left-to-right, as:

Bit 1: name field

Bit 2: currentPrice field

Bit 3: priceHistory field

Bit 4: termsAndConditions field

The return value of getRequiredFields encodes what fields must be marshalled for a particular message from the server to the client. For example, a return value of 0101 indicates that only the currentPrice and termsAndConditions fields must be included in the message.

In a first example, suppose the server 102 services two types of client applications 104, a desktop client and a PDA client. The desktop client displays to the user all information from the Stock data structure, but the PDA client does not display the price history information due to a limited user interface. The programmer could optimize the server application 102 with a decision procedure 416 as follows:

function getRequiredFields1( ) {

if (client is desktop) {

return 1111;

else /* client is PDA */ {

return 1101;} }

In a second example, suppose the system is coded to understand that registered users have previously indicated that they accept all terms and conditions without review, while unregistered users have not so indicated. Then the message can be optimized by only sending the terms and conditions to unregistered users. We combine this logic with the logic of the first example, encoding a decision procedure as follows:

function getRequiredFields2( ) {

if (client is registered) {

return 1110 bitwise-and getRequiredFields1( );

}else /* client is not registered */ {

return 1111 bitwise-and getRequiredFields1( );}}

In a third example, suppose the system runs twenty-four hours per day, but trades can only be processed between 9 AM and 5 PM. At other hours, the client application 104 will never prompt the user to accept terms and conditions, so this information need not be communicated from server to client. Combining this rule with the previous two examples:

function getRequiredFields3( ) {

if (0900hr <= currentTime <= 1700hr) {

return 1111 bitwise-and getRequiredFields2( );

} else /* trading is not possible */ {

return 1110 bitwise-and getRequiredFields2( );}}

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following: a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

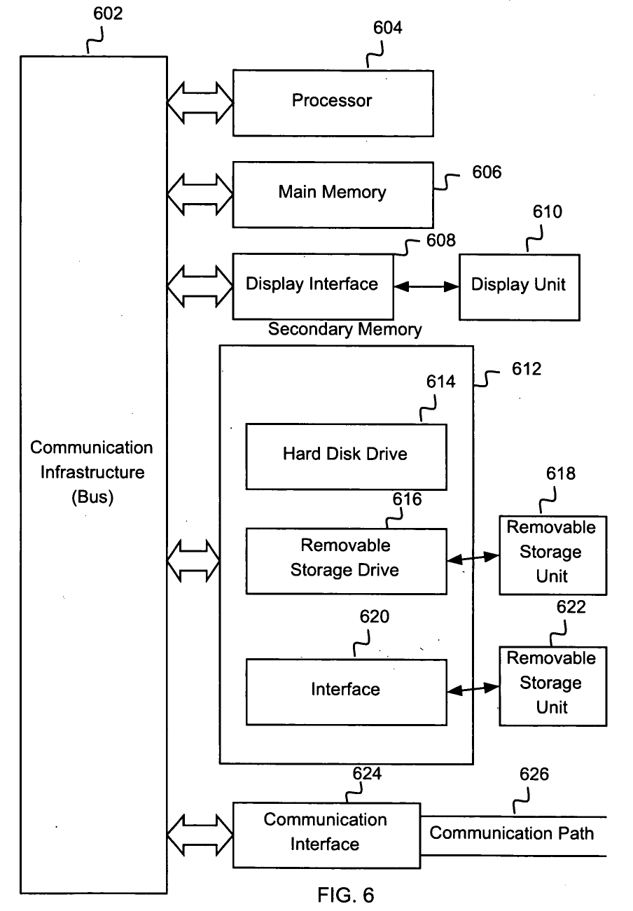

FIG. 6 is a high level block diagram showing an information processing system useful for implementing one embodiment of the present invention. The computer system includes one or more processors, such as processor 604. The processor 604 is connected to a communication infrastructure 602 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 608 that forwards graphics, text, and other data from the communication infrastructure 602 (or from a frame buffer not shown) for display on the display unit 610. The computer system also includes a main memory 606, preferably random access memory (RAM), and may also include a secondary memory 612. The secondary memory 612 may include, for example, a hard disk drive 614 and/or a removable storage drive 616, representing a floppy disk drive, a magnetic tape drive, an optical disk drive, etc. The removable storage drive 616 reads from and/or writes to a removable storage unit 618 in a manner well known to those having ordinary skill in the art. Removable storage unit 618, represents a floppy disk, a compact disc, magnetic tape, optical disk, etc. which is read by and written to by removable storage drive 616. As will be appreciated, the removable storage unit 618 includes a computer readable medium having stored therein computer software and/or data.

In alternative embodiments, the secondary memory 612 may include other similar means for allowing computer programs or other instructions to be loaded into the computer system. Such means may include, for example, a removable storage unit 622 and an interface 620. Examples of such may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to the computer system.

The computer system may also include a communications interface 624. Communications interface 624 allows software and data to be transferred between the computer system and external devices. Examples of communications interface 624 may include a modem, a network interface (such as an Ethernet card), a communications port, a PCMCIA slot and card, etc. Software and data transferred via communications interface 624 are in the form of signals which may be, for example, electronic, electromagnetic, optical, or other signals capable of being received by communications interface 624. These signals are provided to communications interface 624 via a communications path (i.e., channel) 626. This channel 626 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 606 and secondary memory 612, removable storage drive 616, a hard disk installed in hard disk drive 614, and signals. These computer program products are means for providing software to the computer system. The computer readable medium allows the computer system to read data, instructions, messages or message packets, and other computer readable information from the computer readable medium.

Computer programs (also called computer control logic) are stored in main memory 606 and/or secondary memory 612. Computer programs may also be received via communications interface 624. Such computer programs, when executed, enable the computer system to perform the features of the present invention as discussed herein. In particular, the computer programs, when executed, enable the processor 604 to perform the features of the computer system. Accordingly, such computer programs represent controllers of the computer system.

What has been shown and discussed is a highly-simplified depiction of a programmable computer apparatus. Those skilled in the art will appreciate that other low-level components and connections are required in any practical application of a computer apparatus.

Therefore, while there has been described what is presently considered to be the preferred embodiment, it will be understood by those skilled in the art that other modifications can be made within the spirit of the invention.

What is claimed is:

1. A method for communicating information in a data structure between applications, the method comprising:
receiving a request from a first application for sending information in a data structure to a second application;
reading information from a run-time environment of the first application;
identifying, based on the information, portions of the data structure to send;
marshalling the portions of the data structure that were identified; and
sending the portions of the data structure that were marshalled to the second application.

2. The method of claim 1, wherein the element of receiving comprises:
receiving a request from a first application for sending information in an object to a second application.

3. The method of claim 2, wherein the element of reading comprises:
reading a run-time environment value from a run-time environment of the first application, wherein the run-time environment value is any one of a time of day, existence of a previous occurrence, a type of the second application, a value associated with the second application and a bandwidth value.

4. The method of claim 2, wherein the element of identifying comprises:
identifying, based on the information, portions of the object to send.

5. The method of claim 4, wherein the element of marshalling comprises:
marshalling the portions of the object that were identified.

6. The method of claim 5, wherein the element of sending comprises:
sending the portions of the object that were marshalled to the second application.

7. The method of claim 1, wherein the element of reading comprises:
reading a run-time environment value from a run-time environment of the first application, wherein the run-time environment value is any one of a time of day, existence of a previous occurrence, a type of the second application, a value associated with the second application and a bandwidth value.

8. An information processing system for communicating information in a data structure between applications, comprising:
a first application for sending information in a data structure to a second application;
a processor configured for:
reading information from a run-time environment of the first application;
identifying, based on the information, portions of the data structure to send; and
marshalling the portions of the data structure that were identified; and
a transmitter for sending the portions of the data structure that were marshalled to the second application.

9. The information processing system of claim 8, wherein the data structure is an object.

10. The information processing system of claim 9, wherein the information is a run-time environment value including any one of a time of day, existence of a previous occurrence, a type of the second application, a value associated with the second application and a bandwidth value.

11. The information processing system of claim 9, wherein the element of identifying comprises:
identifying, based on the information, portions of the object to send.

12. The information processing system of claim 11, wherein the element of marshalling comprises:
marshalling the portions of the object that were identified.

13. The information processing system of claim 12, wherein the element of sending comprises:
sending the portions of the object that were marshalled to the second application.

14. The information processing system of claim 8, wherein the information is a run-time environment value including any one of a time of day, existence of a previous occurrence, a type of the second application, a value associated with the second application and a bandwidth value.

15. A computer readable medium including computer instructions for communicating information in a data structure between applications, the computer instructions including instructions for:
receiving a request from a first application for sending information in a data structure to a second application;
reading information from a run-time environment of the first application;
identifying, based on the information, portions of the data structure to send;
marshalling the portions of the data structure that were identified; and
sending the portions of the data structure that were marshalled to the second application.

16. The computer readable medium of claim 15, wherein the instructions for receiving comprise:
receiving a request from a first application for sending information in an object to a second application.

17. The computer readable medium of claim 16, wherein the instructions for reading comprise:
reading a run-time environment value from a run-time environment of the first application, wherein the run-time environment value is any one of a time of day, existence of a previous occurrence, a type of the second application, a value associated with the second application and a bandwidth value.

18. The computer readable medium of claim 16, wherein the instructions for identifying comprise:
identifying, based on the information, portions of the object to send.

19. The computer readable medium of claim 18, wherein the instructions for marshalling comprise:
marshalling the portions of the object that were identified.

20. The computer readable medium of claim 19, wherein the instructions for sending comprise:
sending the portions of the object that were marshalled to the second application.
